(19) United States
(12) Patent Application Publication
(10) Pub. No.: US 2023/0135005 A1
(43) Pub. Date: May 4, 2023

(54) PREDICTIVE TARGET EVENT EVALUATION USING SEGMENT VALUATION DISTRIBUTIONS FOR PROPOSED EVENT ALTERNATIVES

(71) Applicant: Optum, Inc., Minnetonka, MN (US)

(72) Inventors: Alice N. Bluestone, Evanston, IL (US); Junia Mulia, Aurora, IL (US); Luke W. Salzwedel, Minneapolis, MN (US)

(21) Appl. No.: 17/517,099

(22) Filed: Nov. 2, 2021

(51) Int. Cl. G06N 5/02

(52) U.S. Cl. CPC G06N 5/02

(57) ABSTRACT

Various embodiments of the present invention provide methods, apparatus, systems, computing devices, computing entities, and/or the like for predictive target event evaluation. Certain embodiments of the present invention utilize systems, methods, and computer program products that perform predictive target event evaluation using at least one of a valuation distribution data object, historical event data, and a granularity-adjusted event feature combination.

### BACKGROUND

Various embodiments of the present invention address technical challenges related to performing target event evaluation. Various embodiments of the present invention disclose innovative techniques for efficiently and effectively performing predictive target event evaluation using various predictive data analysis techniques.

### BRIEF SUMMARY

In general, various embodiments of the present invention provide methods, apparatus, systems, computing devices, computing entities, and/or the like for performing predictive target event evaluation. Certain embodiments of the present invention utilize systems, methods, and computer program products that perform predictive target event evaluation using at least one of a valuation distribution data object, historical event data, and a granularity-adjusted event feature combination.

In accordance with one aspect, a method is provided. In one embodiment, the method comprises: identifying a target event, wherein the target event is characterized by a plurality of target event features and a target event valuation; determining, based at least in part on the plurality of target event features, one or more proposed event alternatives; for each proposed event alternative: determining a valuation distribution entry in a valuation distribution data object for the proposed event alternative, wherein the valuation distribution entry comprises a granularity-adjusted event feature combination for the proposed event alternative and a segment valuation distribution for the granularity-adjusted event feature combination; determining, based at least in part on the segment valuation distribution for the valuation distribution entry, a below-target event valuation and a below-target event valuation likelihood for the proposed event alternative; and determining, based at least in part on the target event valuation, the below-target event valuation, and the below-target event valuation likelihood, an estimated utility measure for the proposed event alternative; and performing one or more prediction-based actions based at least in part on each estimated utility measure.

In accordance with another aspect, a computer program product is provided. The computer program product may comprise at least one computer-readable storage medium having computer-readable program code portions stored therein, the computer-readable program code portions comprising executable portions configured to: identify a target event, wherein the target event is characterized by a plurality of target event features and a target event valuation; determine, based at least in part on the plurality of target event features, one or more proposed event alternatives; for each proposed event alternative: determine, a valuation distribution entry in a valuation distribution data object for the proposed event alternative, wherein the valuation distribution entry comprises a granularity-adjusted event feature combination for the proposed event alternative and a segment valuation distribution for the granularity-adjusted event feature combination; determine, based at least in part on the segment valuation distribution for the valuation distribution entry, a below-target event valuation and a below-target event valuation likelihood for the proposed event alternative; and determine, based at least in part on the target event valuation, the below-target event valuation, and the below-target event valuation likelihood, an estimated utility measure for the proposed event alternative; and perform one or more prediction-based actions based at least in part on each estimated utility measure.

In accordance with yet another aspect, an apparatus comprising at least one processor and at least one memory including computer program code is provided. In one embodiment, the at least one memory and the computer program code may be configured to, with the processor, cause the apparatus to: identify a target event, wherein the target event is characterized by a plurality of target event features and a target event valuation; determine, based at least in part on the plurality of target event features, one or more proposed event alternatives; for each proposed event alternative: determine, a valuation distribution entry in a valuation distribution data object for the proposed event alternative, wherein the valuation distribution entry comprises a granularity-adjusted event feature combination for the proposed event alternative and a segment valuation distribution for the granularity-adjusted event feature combination; determine, based at least in part on the segment valuation distribution for the valuation distribution entry, a below-target event valuation and a below-target event valuation likelihood for the proposed event alternative; and determine, based at least in part on the target event valuation, the below-target event valuation, and the below-target event valuation likelihood, an estimated utility measure for the proposed event alternative; and perform one or more prediction-based actions based at least in part on each estimated utility measure.

### BRIEF DESCRIPTION OF THE DRAWINGS

Having thus described the invention in general terms, reference will now be made to the accompanying drawings, which are not necessarily drawn to scale, and wherein:

FIG. 1 provides an exemplary overview of a system that can be used to practice embodiments of the present invention.

FIG. 2 provides an example predictive data analysis computing entity, in accordance with some embodiments discussed herein.

FIG. 3 provides an example external computing entity, in accordance with some embodiments discussed herein.

FIG. 4 is a flowchart diagram of an example process for predictive target event evaluation, in accordance with some embodiments discussed herein.

FIG. 5 is a flowchart diagram of an example process for generating an initial valuation distribution data object, in accordance with some embodiments discussed herein.

FIG. 6 is a flowchart diagram of an example process for generating a valuation distribution data object, in accordance with some embodiments discussed herein.

FIG. 7 is a flowchart diagram of an example process for determining a granularity-adjusted event feature combination, in accordance with some embodiments discussed herein.

FIG. 8 is a flowchart diagram of an example process for generating one or more estimated utility measures, in accordance with some embodiments discussed herein.

FIG. 9 is a flowchart diagram of an example process of using a valuation distribution data object to generate one or more estimated utility measures, in accordance with some embodiments discussed herein.

FIG. 10 provides an operational example of using a valuation distribution data object to generate one or more estimated utility measures, in accordance with some embodiments discussed herein.

FIG. 11 provides an operational example of a prediction output user interface, in accordance with some embodiments discussed herein.

### DETAILED DESCRIPTION

Various embodiments of the present invention now will be described more fully hereinafter with reference to the accompanying drawings, in which some, but not all, embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout. Moreover, while certain embodiments of the present invention are described with reference to predictive data analysis, one of ordinary skill in the art will recognize that the disclosed concepts can be used to perform other types of data analysis.

### I. Overview and Technical Improvements

Various embodiments of the present invention provide techniques for performing predictive target event evaluation with linear computational complexity. For example, according to some embodiments of the present invention, a predictive target event evaluation for a target event can be performed by: (i) determining one or more proposed event alternatives for the target event by querying an alternatives table based on target event features of the target event; (ii) for each proposed event alternative, determining a segment valuation distribution based on a valuation distribution data object (e.g., a look-up table); and (iii) determining an estimated utility measure for each proposed event alternative based on the segment valuation distribution for the proposed event alternative. In this exemplary embodiments, step/operation (i) can be performed with O(m) linear complexity (with m being the size of the alternatives table), step/operation (ii) can be performed with O(n) linear complexity (with n being the size of the valuation distribution data object), and step/operation (iii) can be performed with constant computational complexity. Accordingly, the overall process can be performed with a linear computational complexity, which makes this process (and similar processes described herein) desirable from a computational efficiency approach. Accordingly, various embodiments of the present invention improve the computational efficiency of performing predictive target event evaluation and make important technical contributions to the field of predictive data analysis.

An exemplary application of various embodiments of the proposed invention relate to a predictive drug pricing system for identifying savings opportunities for a member. In some embodiments, a proposed system utilizes historical claims data to determine cost trending at specific aggregate levels including but not limited to plan design, benefit utilization, formulary, pharmacy type, and location (i.e., transaction features). Statistical analysis may be applied to aggregate pricing at the hierarchical levels to determine pricing variance and likelihood of savings. Expected savings and savings likelihood may then be applied to each incoming claim to identify savings opportunities. The system may consider local pharmacies available, the consumer's potential benefit design, the current prescription filled, and the quantity of fill in determining the savings opportunities so as to propose the best and most relevant alternatives.

In some embodiments, a pricing lookup table is generated using a rules-based algorithm determined based on analyzing claims history. According to some embodiments, claims history, retrieved from a data warehouse, is analyzed to determine cost drivers. Utilizing the cost drivers, the retrieved data is divided into segments based on member characteristics such as member location, pharmacy, formulary, and benefit design. For each segment, a set of prices are defined, where each price is associated with a likelihood level. Statistical analysis may be performed to summarize the prices at various likelihood levels. In some embodiments, for each drug and member segment, a histogram of historical costs may be utilized to summarize price levels and savings likelihood scores. In some embodiments, by utilizing the pricing lookup table, the pricing system estimates real-time expected savings likelihood for new incoming claims (i.e., proposed transactions) by matching the corresponding member to the appropriate segment. The system then determines a predicted savings amount and a savings likelihood score through statistical analysis.

### II. Definitions of Certain Terms

The term “target event” may refer to a data entity that describes an event feature combination for a target transaction. An example target event may be an event feature combination for a pharmaceutical transaction (e.g., drug item purchase, prescription fill, and/or the like). The target event may describe one or more target event features (e.g., pharmacy type, pharmacy name, drug item, formulary, benefit design, and/or the like) for a target transaction associated with a member profile. In some embodiments, the target event may be identified based at least in part on one or more historical event transactions for the member profile. As an example, a target event may be identified based at least in part on one or more past prescription fill, past drug item purchase, past pharmaceutical claim entry, and/or the like associated with the member profile. In some embodiments, the target event may be identified based at least in part on a target transaction inquiry. As an example, a target event may be identified based at least in part on receiving an inquiry with respect to a future pharmaceutical transaction (e.g., a transaction that has not occurred). In some embodiments, the target transaction inquiry may be received from a computing entity associated with the member profile/patient. In some embodiments, the target event may be characterized by a plurality of target event features and a target event valuation. In some embodiments, the target event may describe a target event with respect to which a predictive data analysis system seeks to perform one or more prediction-based actions.

The term “target event feature” may refer to a data entity that describes an event feature of a target event. Examples of target event features include pharmacy type, pharmacy name, pharmacy location, drug item, member location, formulary, benefit design, and/or the like.

The term “target event valuation” may refer to a data entity that describes the valuation associated with a target event. An example target event valuation may be the price of a drug item associated with a pharmaceutical transaction (e.g., target transaction). As an example, a target event valuation may be $20 for Tylenol at Walgreens. As another example, a target event valuation may be $15 for Tylenol at Walgreens. As yet another example, a target event valuation may be $15 for Ibuprofen at Walgreens. In some embodiments, the target event valuation may be configured to be used at least in part to generate an estimated utility measure, which in turn may be configured to be used to perform one or more prediction-based actions.

The term “proposed event alternative” may refer to a data entity that describes an event feature combination for a proposed transaction deemed similar to (e.g., deemed to be an acceptable alternative for) the event feature combination of a target transaction. An example proposed event alternative may be an event feature combination of a proposed pharmaceutical transaction that is different from the event feature combination of a target event in some respect but deemed similar enough to be considered an alternative. As an example, an event feature combination comprising [Tylenol, CVS] may be identified as a proposed event alternative of a target event with event feature combinations comprising [Ibuprofen, CVS]. As another example, an event feature combination comprising [Zocor, CVS] may be identified as a proposed event alternative of a target event with event feature combinations comprising [Zocor, Walgreens]. In some embodiments, a proposed event feature alternative may be identified based at least in part on comparing one or more target event features of the target event to one or more event features of the proposed event alternatives. For example, a proposed event alternative for a target event may describe a proposed event alternative with a measure of similarity that satisfies a similarity threshold. In some embodiments one or more proposed event alternatives may be identified for a target event. In some embodiments, a proposed event alternative may be received/retrieved from an event alternatives database.

The term “valuation distribution data object” may refer to a data object that is configured to describe a look-up table characterized by a plurality of valuation distribution entries corresponding to a plurality of event feature combinations. A valuation distribution data object may describe a look up table with n valuation distribution entries. An example valuation distribution data object may be a price look-up table with respect to past claims (e.g., pharmaceutical claims). In some embodiments, generating the valuation distribution data object may comprise removing outliers from an initial valuation distribution data object. In some embodiments, generating the valuation distribution data object may comprise performing granularity adjustment (e.g., data aggregation) on the initial valuation distribution data object to generate a valuation distribution data object comprising granularity-adjusted event feature combinations.

The term “valuation distribution entry” may refer to an entry in a valuation distribution data object, where the valuation distribution entry describes an event feature combination (e.g., a combination of one or more of a pharmacy type, a pharmacy name, a pharmacy location, a drug item, a member location, a formulary, a benefit design, and/or the like). As an example, a particular valuation distribution entry may describe [Zocor, CVS, Cleveland, HMO]. As another example, a particular valuation distribution entry may describe [Ibuprofen, Walgreens, Ohio, HMO, Optum]. In some embodiments, a valuation distribution entry may be characterized by an event feature combination and a segment valuation distribution for the event feature combination. In some embodiments, the event feature combination of a valuation distribution entry may be a granularity-adjusted event feature combination.

The term “granularity-adjusted event feature combination” may refer to a data entity that describes an event feature combination for a valuation distribution entry whose granularity has been adjusted to ensure that the event feature combination is associated with a threshold number of past claims. For example, in some embodiments, a valuation distribution data object may comprise a plurality of valuation distribution entries, where each valuation distribution entry is associated with at least a minimum number of past pharmaceutical claims. In some embodiments, determining the granularity-adjusted event feature combination may comprise determining a highest-granularity related event feature combination whose respective occurrence count (e.g., insurance claim count) satisfies an occurrence count threshold. For example, in some embodiments, if a particular valuation distribution entry that describes [Zocor, CVS, Cleveland, HMO] does not have a respective occurrence count that satisfies an occurrence count threshold, then the granularity of the particular valuation distribution entry may be adjusted upwards to generate the granularity-adjusted event feature combination [Zocor, CVS, Ohio, HMO]. If the granularity-adjusted event feature combination [Zocor, CVS, Ohio, HMO] has a respective occurrence count that satisfies an occurrence count threshold, then the valuation distribution data object will have a valuation distribution entry corresponding to the granularity-adjusted event feature combination [Zocor, CVS, Ohio, HMO].

The term “related event feature combination” may refer to a data entity that describes a corresponding highest-granularity event feature combination or any event feature combination that has been generated by reducing the granularity of the highest-granularity event feature combination. As an example, [Tylenol, Georgia] may be a related event feature combination for [Tylenol, Atlanta]. As another example, [Pain Medication, Georgia] may be a related event feature combination for [Tylenol, Atlanta]. As yet another example, [Pain Medication, Atlanta] may be a related event feature combination for [Tylenol, Georgia].

The term “segment valuation distribution” may refer to a data entity that describes a valuation distribution (e.g., a statistical price distribution) with respect to past claims for an event feature combination. A segment valuation distribution may describe one or more valuation percentiles, such as one or more price percentiles. An example segment valuation distribution may be a percentile price distribution of past claims associated with an event feature combination of a valuation distribution entry. The segment valuation distribution may comprise n percentiles for n prices and/or range of prices, where a percentile may describe the number of past claims associated with the percentile. As an example, 80^{th} percentile may describe that 80% of the past claims associated with a corresponding event feature combination paid a price defined by the 80^{th} percentile.

The term “below-target event valuation” may refer to a data entity that describes the highest valuation by a recorded percentile of past claims in a segment valuation distribution below the target valuation. As an example, consider where a target event valuation is $70 and where the highest valuation by a recorded percentile of past claims below $70 is $65. In the noted example, the below-target even valuation is $65. In some embodiments, the below-target event valuation may describe the highest valuation by a recorded percentile of past claims below the target valuation whose recorded percentile satisfies a percentile threshold. In some embodiments, the below-target event valuation may be determined based at least in part on the corresponding segment valuation distribution. In some embodiments, the below-target event valuation may be configured to be used at least in part to generate an estimated utility measure, which in turn may be configured to be used to perform one or more prediction-based actions.

The term “below-target event valuation likelihood” may refer to a data entity that describes the recorded percentile of past claims of a valuation distribution entry that are below the target valuation. A below-target event valuation likelihood for a proposed event alternative may describe an estimated likelihood that the corresponding below-target event valuation may be obtained by a member profile associated with the target event. In some embodiments, a below-target event valuation likelihood may describe a confidence score based at least in part on the number of past claims associated with the below-target event valuation. In some embodiments, the below-target event valuation likelihood may be configured to be used at least in part to generate an estimated utility measure, which in turn may be configured to be used to perform one or more prediction-based actions.

The term “estimated utility measure” may refer to a data entity that is configured to describe a predicted utility opportunity (e.g., a predicted savings opportunity measure) for a proposed event alternative identified for a target event. In some embodiments, the estimated utility measure may be determined based at least in part on a target event valuation of a target event, a below-target event valuation for a proposed event alternative associated with the target event, and a below-target event valuation likelihood for the below-target event valuation. In some embodiments, the estimated utility measure may be configured to be used to perform one or more prediction-based actions. In some embodiments, the estimated utility measure may be determined utilizing a formula, algorithm, and/or the like. In some embodiments, the estimated utility measure may be determined using the formula/algorithm:

Estimated Utility Measure=[target event valuation−below-target event valuation]*[below-target event valuation likelihood] Equation 1

### III. Computer Program Products, Methods, and Computing Entities

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatuses, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### IV. Exemplary System Framework

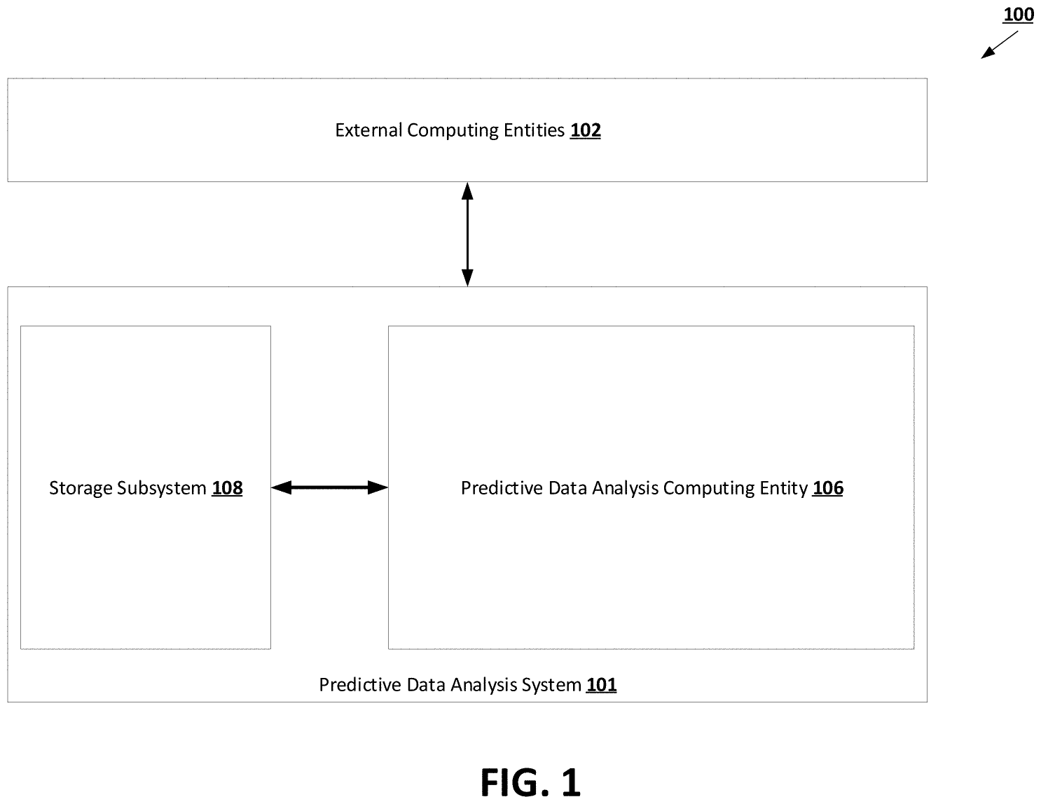

FIG. 1 is a schematic diagram of an example system architecture 100 for performing predictive data analysis steps/operations and generating corresponding user interface data (e.g., for providing and/or updating a user interface) in accordance with some embodiments herein. The system architecture 100 includes a predictive data analysis system 101 comprising a predictive data analysis computing entity 106 configured to generate predictive outputs that lead to performing one or more prediction-based actions. The predictive data analysis system 101 may communicate with one or more external computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The system architecture 100 includes a storage subsystem 108 configured to store at least a portion of the data utilized by the predictive data analysis system 101. The predictive data analysis computing entity 106 may be in communication with one or more external computing entities 102. The predictive data analysis computing entity 106 may be configured to receive requests and/or data from external computing entities 102, process the requests and/or data to generate predictive outputs (e.g., predictive data analysis data objects), and provide the predictive outputs to the external computing entities 102. The external computing entity 102 (e.g., management computing entity) may periodically update/provide raw input data to the predictive data analysis system 101. The external computing entities 102 may further generate user interface data (e.g., one or more data objects) corresponding to the predictive outputs and may provide (e.g., transmit, send and/or the like) the user interface data corresponding with the predictive outputs for presentation to user computing entities operated by end-users.

The storage subsystem 108 may be configured to store at least a portion of the data utilized by the predictive data analysis computing entity 106 to perform predictive data analysis steps/operations and tasks. The storage subsystem 108 may be configured to store at least a portion of operational data and/or operational configuration data including operational instructions and parameters utilized by the predictive data analysis computing entity 106 to perform predictive data analysis steps/operations in response to requests. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### Exemplary Predictive Data Analysis Computing Entity

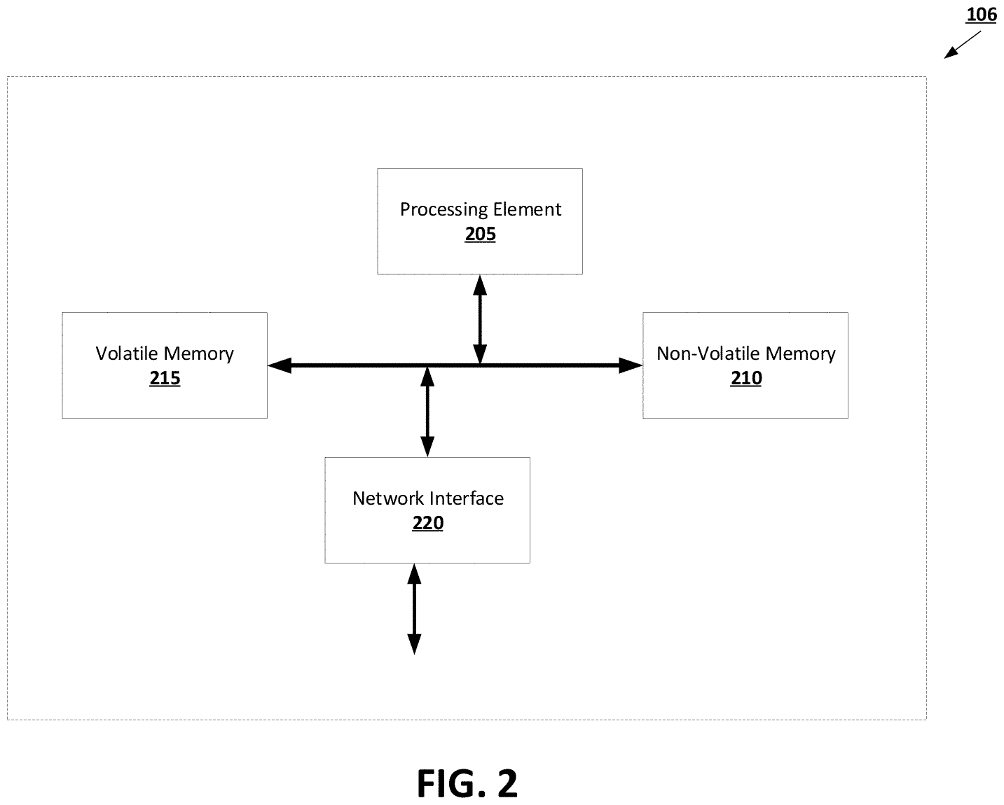

FIG. 2 provides a schematic of a predictive data analysis computing entity 106 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, steps/operations, and/or processes described herein. Such functions, steps/operations, and/or processes may include, for example, transmitting, receiving, operating on, processing, displaying, storing, determining, creating/generating, monitoring, evaluating, comparing, and/or similar terms used herein interchangeably. In one embodiment, these functions, steps/operations, and/or processes can be performed on data, content, information, and/or similar terms used herein interchangeably.

As indicated, in one embodiment, the predictive data analysis computing entity 106 may also include a network interface 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the predictive data analysis computing entity 106 may include or be in communication with a processing element 205 (also referred to as processors, processing circuitry, and/or similar terms used herein interchangeably) that communicate with other elements within the predictive data analysis computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the predictive data analysis computing entity 106 may further include or be in communication with non-volatile media (also referred to as non-volatile storage, memory, memory storage, memory circuitry and/or similar terms used herein interchangeably). In one embodiment, the non-volatile storage or memory may include at least one non-volatile memory 210, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the predictive data analysis computing entity 106 may further include or be in communication with volatile media (also referred to as volatile storage, memory, memory storage, memory circuitry and/or similar terms used herein interchangeably). In one embodiment, the volatile storage or memory may also include at least one volatile memory 215, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the predictive data analysis computing entity 106 with the assistance of the processing element 205 and operating system.

As indicated, in one embodiment, the predictive data analysis computing entity 106 may also include a network interface 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive data analysis computing entity 106 may be configured to communicate via wireless client communication networks using any of a variety of protocols, such as general packet radio service (GPRS), Universal Mobile Telecommunications System (UMTS), Code Division Multiple Access 2000 (CDMA2000), CDMA2000 1X (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the predictive data analysis computing entity 106 may include or be in communication with one or more input elements, such as a keyboard input, a mouse input, a touch screen/display input, motion input, movement input, audio input, pointing device input, joystick input, keypad input, and/or the like. The predictive data analysis computing entity 106 may also include or be in communication with one or more output elements (not shown), such as audio output, video output, screen/display output, motion output, movement output, and/or the like.

### Exemplary External Computing Entity

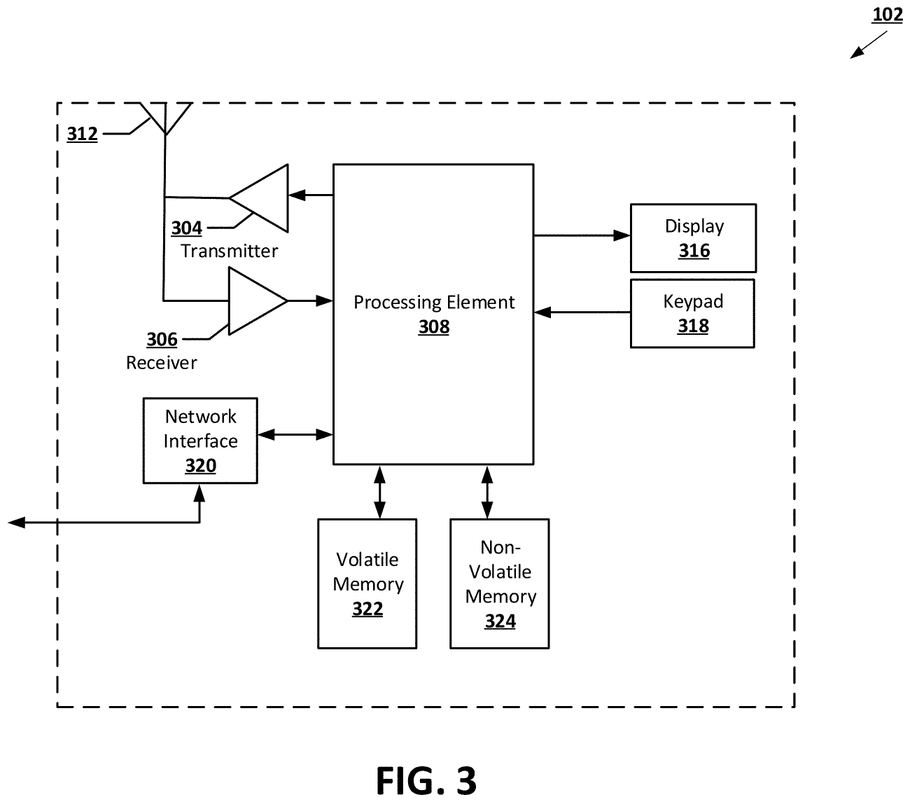

FIG. 3 provides an illustrative schematic representative of an external computing entity 102 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, steps/operations, and/or processes described herein. External computing entities 102 can be operated by various parties. As shown in FIG. 3, the external computing entity 102 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the external computing entity 102 may be capable of operating with one or more air interface standards, communication protocols, modulation types, and access types. More particularly, the external computing entity 102 may operate in accordance with any of a number of wireless communication standards and protocols, such as those described above with regard to the predictive data analysis computing entity 106. In a particular embodiment, the external computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the external computing entity 102 may operate in accordance with multiple wired communication standards and protocols, such as those described above with regard to the predictive data analysis computing entity 106 via a network interface 320.

Via these communication standards and protocols, the external computing entity 102 can communicate with various other entities using concepts such as Unstructured Supplementary Service Data (US SD), Short Message Service (SMS), Multimedia Messaging Service (MMS), Dual-Tone Multi-Frequency Signaling (DTMF), and/or Subscriber Identity Module Dialer (SIM dialer). The external computing entity 102 can also download changes, add-ons, and updates, for instance, to its firmware, software (e.g., including executable instructions, applications, program modules), and operating system.

According to one embodiment, the external computing entity 102 may include location determining aspects, devices, modules, functionalities, and/or similar words used herein interchangeably. For example, the external computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the external computing entity's 102 position in connection with a variety of other systems, including cellular towers, Wi-Fi access points, and/or the like. Similarly, the external computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The external computing entity 102 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the external computing entity 102 to interact with and/or cause display of information/data from the predictive data analysis computing entity 106, as described herein. The user input interface can comprise any of a number of devices or interfaces allowing the external computing entity 102 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the external computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The external computing entity 102 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the external computing entity 102. As indicated, this may include a user application that is resident on the entity or accessible through a browser or other user interface for communicating with the predictive data analysis computing entity 106 and/or various other computing entities.

In another embodiment, the external computing entity 102 may include one or more components or functionality that are the same or similar to those of the predictive data analysis computing entity 106, as described in greater detail above. As will be recognized, these frameworks and descriptions are provided for exemplary purposes only and are not limiting to the various embodiments.

In various embodiments, the external computing entity 102 may be embodied as an artificial intelligence (AI) computing entity, such as an Amazon Echo, Amazon Echo Dot, Amazon Show, Google Home, and/or the like. Accordingly, the external computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### V. Exemplary System Operations

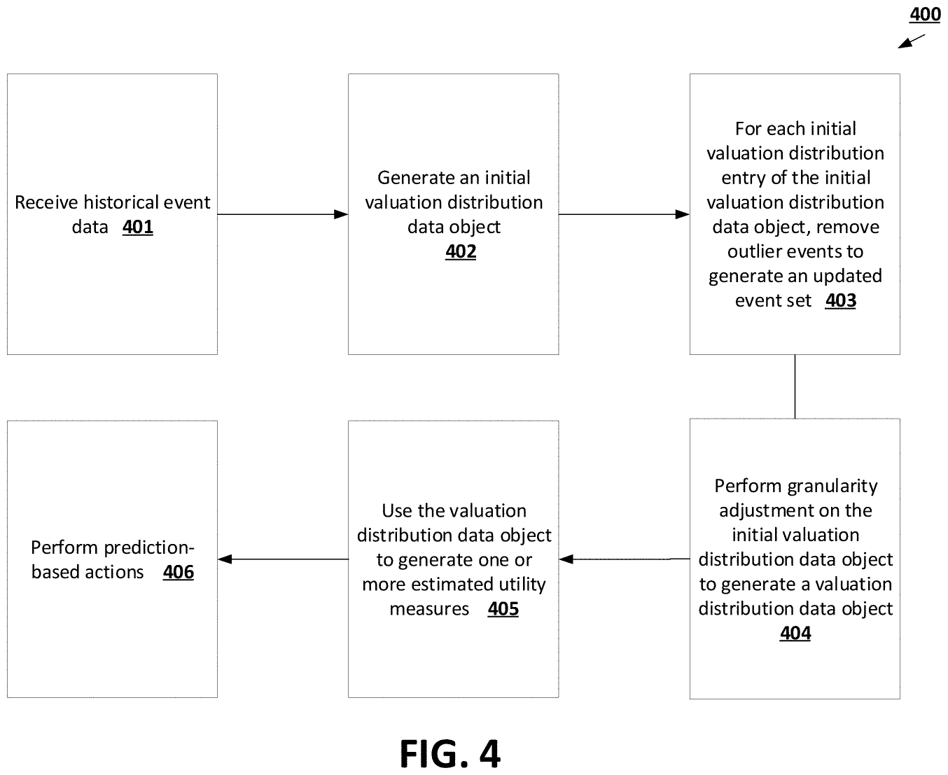

FIG. 4 is a flowchart diagram of an example process 400 for predictive target event evaluation. Via the various steps/operations of the process 400, the predictive data analysis computing entity 106 can utilize rules-based algorithms/modeling to generate a valuation distribution data object for efficiently predicting one or more below-target event valuation for a proposed event alternative for a target event, which in turn may be used to determine one or more estimated utility measures.

The process 400 begins at step/operation 401 when the predictive data analysis computing entity 106 receives historical event data, where the historical event data may comprise a plurality of past claims (e.g., pharmaceutical claims) associated with one or more member profiles. In some embodiments, two or more past claims may be associated with the same member profile. As an example, the historical event data may comprise 100 past claims associated with 100 member profiles. As another example, the historical event data may comprise 200 past claims associated with 150 member profiles.

In some embodiments the historical event data may be historical event data across a period of time. As an example, the historical event data may be historical event data across a period of 6 months. As another example, the historical event data may be historical event data across a period of 24 months. As yet another example, the historical event data may be historical event data across a period of 5 years.

In some embodiments each past claim of the plurality of past claims may be associated with a plurality of event features (e.g., combination of event features). Examples of event features include pharmacy type, pharmacy name, pharmacy location, drug item, member location, formulary, benefit design, and/or the like. Accordingly, in some embodiments, the historical event data may be associated with a plurality of event feature combinations. In some embodiments, the historical event data may be received from a claims database. For example, in some embodiments, the step/operation 401 may be performed when the storage subsystem 108 provides historical event data to the predictive data analysis computing entity 106.

At step/operation 402, the predictive data analysis computing entity 106 generates an initial valuation distribution data object based at least in part on the historical event data. An initial valuation distribution data object may describe an initial look-up table (e.g., initial price look-up table). In some embodiments, the initial valuation distribution data object may be characterized by a plurality of initial valuation distribution entries, where each initial valuation distribution entry may describe an entry in the look-up table. In some embodiments, the initial valuation distribution data object may comprise n initial valuation distribution entries.

In some embodiments, each initial valuation distribution entry may be associated with one or more past claims. For example, a particular initial valuation distribution entry in the valuation distribution data object may be associated with 10 past claims. As another example, a particular initial valuation distribution entry in the initial valuation distribution data object may be associated with 200 past claims. In some embodiments, each initial valuation distribution entry of the initial valuation distribution data object may comprise an event feature combination. As an example, a particular event feature combination may be [Zocor, Walgreens, Boston, PPO]. As another example, a particular event feature combination may be [Zocor, CVS, Somerville, HMO]. Additionally, in some embodiments, the initial valuation distribution data object may comprise a segment valuation distribution entry (discussed further below).

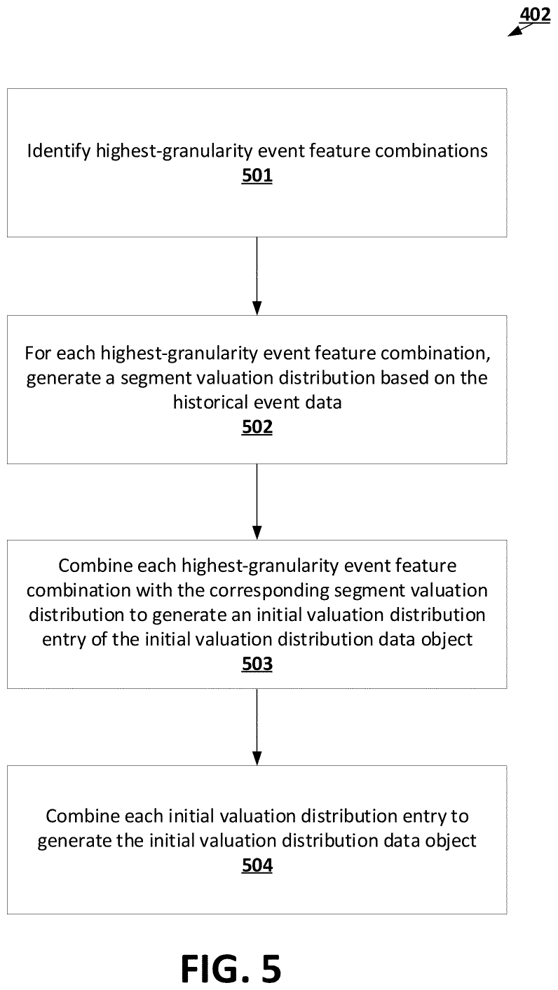

In some embodiments, the step/operation 402 may be performed in accordance with the process depicted in FIG. 5 which is an example process for generating an initial valuation distribution data object. The process that is depicted in FIG. 5 begins at step/operation 501 when the predictive data analysis computing entity 106 identifies a plurality of highest-granularity event feature combinations. A highest-granularity event feature combination may describe a combination of event feature values where each event feature value in the combination is enumerated at the highest level of granularity. For example, for a pharmacy location feature, a city is more granular than a state, and a state is more granular than a country.

At step/operation 502, the predictive data analysis computing entity 106 generates, for each highest-granularity event feature combination, a segment valuation distribution based at least in part on the historical event data. A segment valuation distribution for a highest-granularity event feature combination may describe a set of percentile prices with respect to a drug item associated with the highest-granularity event feature combination. As an example, a particular segment valuation distribution may include a price of $20 that corresponds to 40^{th} percentile. In some embodiments, a segment valuation distribution may describe a price distribution comprising of n percentiles.

In some embodiments, generating the segment valuation distribution may comprise applying statistical analysis to the corresponding highest-granularity event feature combination with respect to the associated drug item and prices. In some embodiments, the predictive data analysis computing entity 106 may be configured to apply a histogram of prices to the corresponding highest-granularity event feature combination to generate the distribution of the prices.

At step/operation 503, the predictive data analysis computing entity 106 combines each highest-granularity event feature combination with the corresponding segment valuation distribution to generate an initial valuation distribution entry of the initial valuation distribution data object. At step/operation 504, the predictive data analysis computing entity 106 combines each initial valuation distribution entry to generate the initial valuation distribution data object.

Returning to FIG. 4, at step/operation 403, for each initial valuation distribution entry of the initial valuation distribution data object, the predictive data analysis computing entity 106 removes outlier events (e.g., outlier past claims) to generate an updated event set.

At step/operation 404, the predictive data analysis computing entity 106 performs a granularity adjustment on the initial valuation distribution data object to generate a valuation distribution data object. In some embodiments, performing the granularity adjustment on the initial valuation distribution data object may comprise aggregating event feature combinations based at least in part on a hierarchy of most specific to least specific event feature.

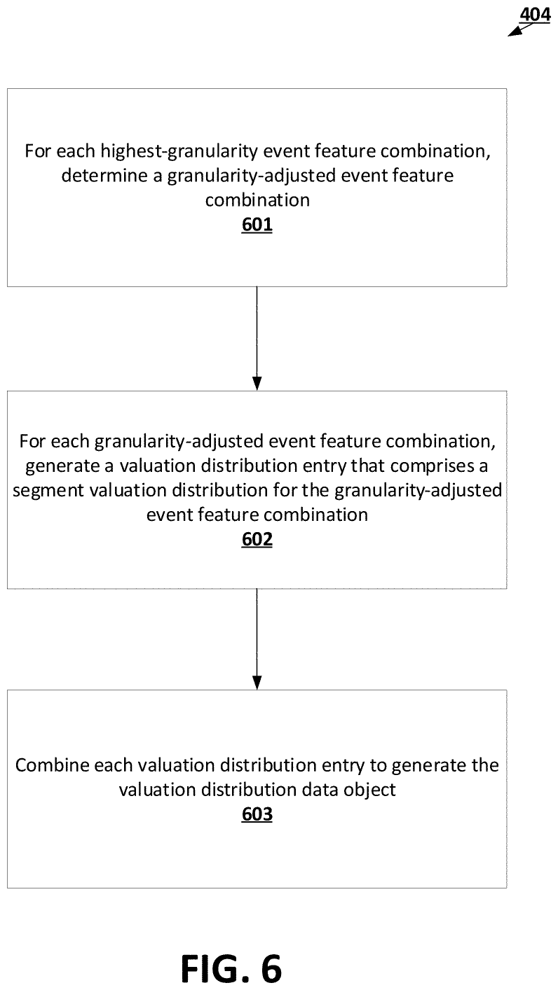

In some embodiments, the step operation 404 may be performed in accordance with the process depicted in FIG. 6 which is an example process for generating a valuation distribution data object based at least in part on an initial valuation distribution data object. The process that is depicted in FIG. 6 begins at step/operation 601 when for each highest-granularity event feature combination of the initial valuation distribution data object, the predictive data analysis computing entity 106 determines a granularity-adjusted event feature combination. A granularity-adjusted event feature combination may describe an event feature combination whose granularity has been adjusted to ensure that the event feature combination is associated with a threshold number of historical claims. In some embodiments the threshold number may be configurable. In some embodiments, granularity adjustment may be performed to improve the accuracy of the predicted output.

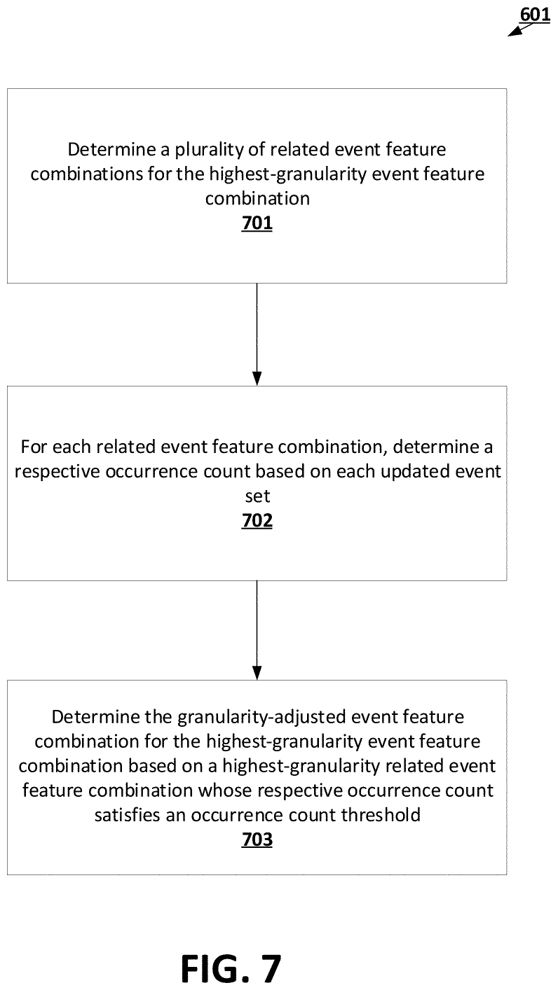

In some embodiments, the step/operation 601 may be performed in accordance with the process depicted in FIG. 7 which is an example process for determining a granularity-adjusted event feature combination for a highest-granularity event feature combination. The process that is depicted in FIG. 7 begins at step/operation 701 when the predictive data analysis computing entity 106 determines a plurality of related event feature combinations for the highest-granularity event feature combination, where the plurality of related event feature combinations comprises the highest-granularity event feature combination and one or more granularity-reduced event feature combinations for the highest-granularity event feature combination. A related event feature combination may describe any framing (e.g., version) of a highest-granularity event feature combination which includes the highest-granularity event feature combination itself and any event feature combination that has been generated by reducing the granularity of the highest-granularity event feature combination. As an example, [Tylenol, Georgia] may be a related event feature combination for [Tylenol, Atlanta]. As another example, [Pain Medication, Georgia] may be a related event feature combination for [Tylenol, Atlanta]. As yet another example, [Pain Medication, Atlanta] may be a related event feature combination for [Tylenol, Georgia].

At step/operation 702, for each related event feature combination, the predictive data analysis computing entity 106 determines a respective occurrence count based at least in part on each updated event set, where an occurrence count may describe the number of past claims associated with an event feature combination (e.g., number of past claims with a given event feature combination).

At step/operation 703, the predictive data analysis computing entity 106 determines the granularity-adjusted event feature combination for the highest-granularity event feature combination based at least in part on a highest-granularity related event feature combination whose respective occurrence count satisfies an occurrence count threshold. An occurrence count for a highest-granularity related event feature combination may describe the number of past claims associated with the highest-granularity related event feature combination. In some embodiments, the occurrence count threshold may be configurable.

Returning to FIG. 6, at step/operation 602, for each granularity-adjusted event feature combination, the predictive data analysis computing entity 106 generates a valuation distribution entry that comprises a segment valuation distribution for the granularity-adjusted event feature combination, where the segment valuation distribution may describe a set of percentile prices with respect to a drug item associated with the granularity-adjusted event feature combination. At step/operation 603, the predictive data analysis computing entity 106 combines each valuation distribution entry to generate the valuation distribution data object.

Returning to FIG. 4, at step/operation 405, the predictive data analysis computing entity 106 generates one or more estimated utility measures using the valuation distribution data object. An estimated utility measure may describe a predicted savings opportunity measure for a proposed event alternative identified for a target event. A target event may describe an event feature combination for a target transaction (e.g., drug item purchase, prescription fill, and/or the like). In some embodiments, a target event may be characterized by: (i) a plurality of target event features (e.g., combination of target event features) and (ii) a target event valuation.

A target event feature may describe an individual event feature of the event feature combination for a target transaction. Examples of target event features include pharmacy type, pharmacy name, pharmacy location, drug item, member location, formulary, benefit design, and/or the like. A target valuation may describe the price of a drug item for a target transaction. For example, in some embodiments, a target event valuation may describe the price of a particular drug item at a particular pharmacy, at a particular location, under a particular benefit design.

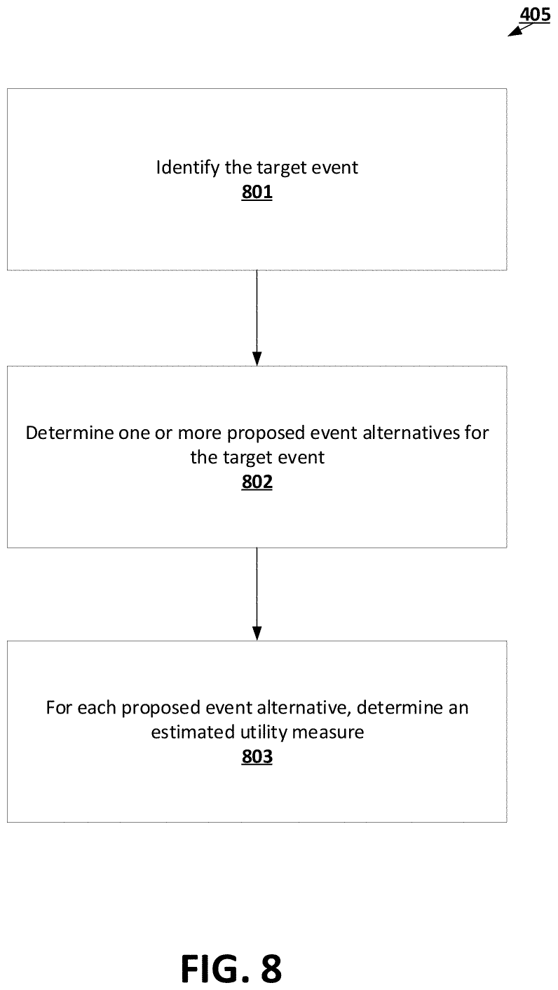

In some embodiments, the step/operation 405 may be performed in accordance with the process depicted in FIG. 8 which is an example process for generating one or more estimated utility measures. The process that is depicted in FIG. 8 begins at step/operation 801 when the predictive data analysis computing entity 106 identifies the target event. In some embodiments, the target event may be identified based at least in part on one or more historical event transactions for a member profile. For example, in some embodiments, the target event may be identified based at least in part on one or more past prescription fill, past drug item purchase, past pharmaceutical claim entry, and/or the like for the member profile. In some embodiments, the target event may be identified based at least in part on a target transaction inquiry. For example, in some embodiments, the target event may be identified based at least in part on receiving an inquiry with respect to a future pharmaceutical transaction (e.g., a transaction that has not occurred). In some embodiments, the target transaction inquiry may be received from a computing entity associated with the member profile/patient.

At step/operation 802, the predictive data analysis computing entity 106 determines one or more proposed event alternatives for the target event. A proposed event alternative may describe an event feature combination for a proposed transaction deemed similar to (e.g., deemed to be an acceptable alternative for) the event feature combination of a target transaction. In some embodiments, a proposed event feature alternative may be identified based at least in part on comparing one or more target event features of the target event to one or more event features of the proposed event alternatives. For example, a proposed event alternative for a target event may describe a proposed event alternative with a measure of similarity that satisfies a similarity threshold.

In some embodiments, the predictive data analysis computing entity 106 may receive the one or more proposed event alternatives from an event alternatives database, where the event alternatives database may comprise a plurality of event alternatives. In some embodiments, the predictive data analysis computing entity 106 may retrieve the one or more proposed event alternatives from an event alternatives database, where the event alternatives database may comprise a plurality of proposed event alternatives.

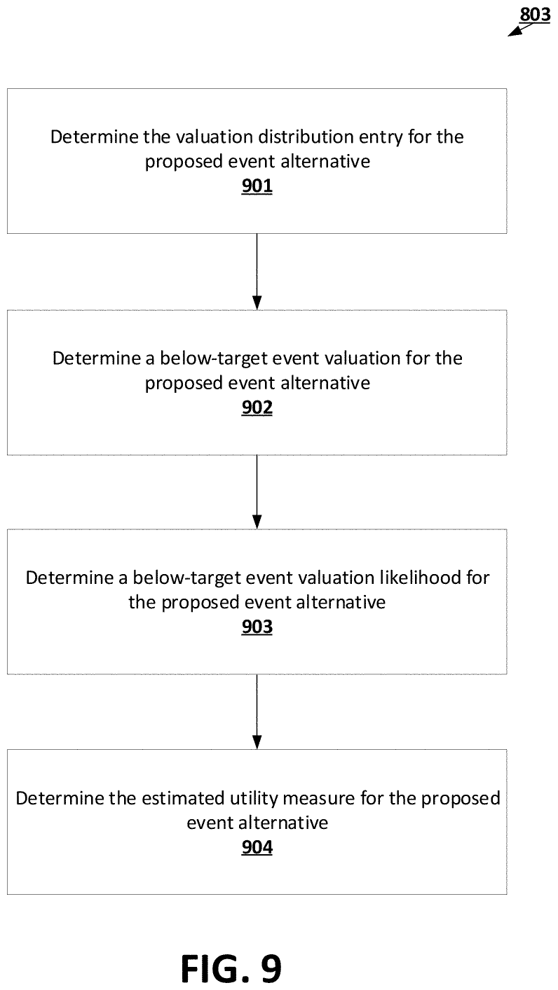

At step/operation 803, for each proposed event alternative, the predictive data analysis computing entity 106 determines an estimated utility measure. In some embodiments, the step/operation 803 may be performed in accordance with the process depicted in FIG.9 which is an example process for determining an estimated utility measure. The process that is depicted in FIG. 9 begins at step/operation 901 when the predictive data analysis computing entity 106 determines the valuation distribution entry in the valuation distribution data object for the proposed event alternative, where the valuation distribution entry comprises a granularity-adjusted event feature combination for the proposed event alternative and a segment valuation distribution for the granularity-adjusted event feature combination.

At step/operation 902, the predictive data analysis computing entity 106 determines a below-target event valuation for the proposed event alternative based at least in part on the segment valuation distribution for the valuation distribution entry. A below-target event valuation may describe the highest valuation by a recorded percentile of past claims below the target valuation. As an example, consider where a target event valuation is $80 and where the highest valuation by a recorded percentile of past claims below $80 is $78. In the noted example, the below-target event valuation is $78. In some embodiments, the below-target event valuation may describe the highest valuation by a recorded percentile of past claims below the target valuation whose recorded percentile satisfies a percentile threshold. In some embodiments, the percentile threshold may be configurable.

At step/operation 903, the predictive data analysis computing entity 106 determines a below-target event valuation likelihood for the proposed event alternative based at least in part on the segment valuation distribution for the valuation distribution entry. The below-target event valuation likelihood may describe the percentile of past claims of a valuation distribution entry that are below the target valuation. For example, the below-target event valuation likelihood for a proposed event alternative may describe the likelihood that the corresponding below-target event valuation may be obtained by a member profile associated with the target event.

In some embodiments, a below-target event valuation likelihood may describe a confidence score based at least in part on the number of past claims associated with the below-target event valuation, where the number of past claims may represent an estimated number of member profiles like the member profile associated with the target event.

At step/operation 904, the predictive data analysis computing entity 106 determines the estimated utility measure for the proposed event alternative based at least in part on the target event valuation, the below-target event valuation, and the below-target event valuation likelihood. In some embodiments, the estimated utility measure may be determined based at least in part on the target event valuation, the below-target event valuation, and the below-target event valuation likelihood using the formula/algorithm/equation:

Estimated Utility Measure=[target event valuation−below-target event valuation]*[below-target event valuation likelihood] Equation 2

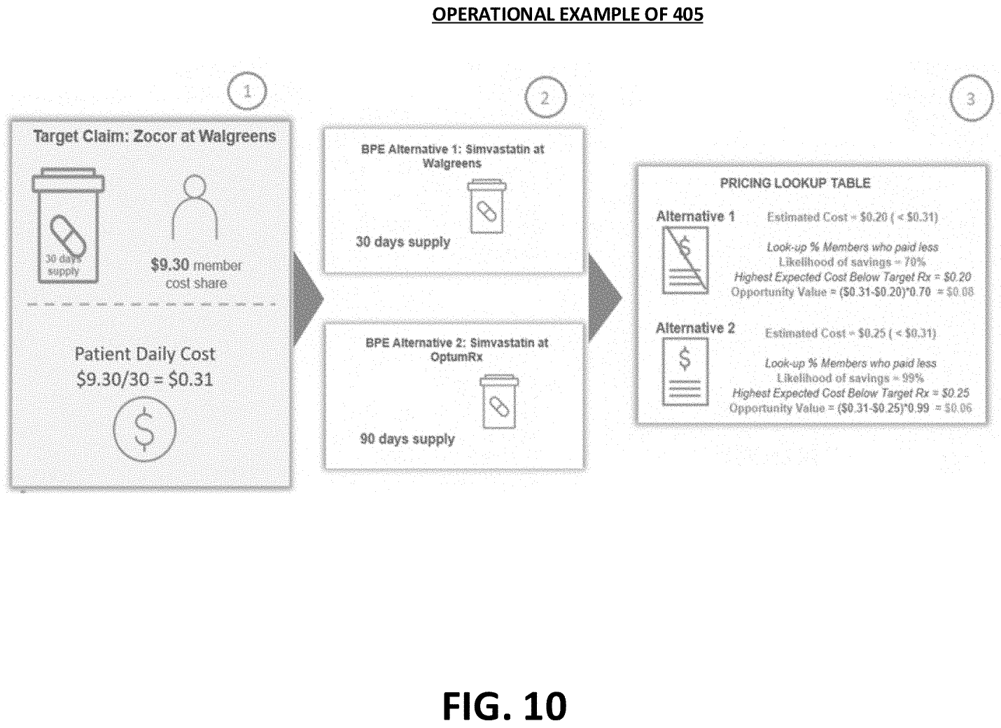

An operational example of performing the step/operation 405 is depicted in FIG. 10. As depicted in FIG. 10, the predictive data analysis computing entity 106 identified two proposed alternatives, [Simvastatin, Walgreens] and [Simvastatin, OptumRx) for a target event (e.g. target claim) [Zocor, Walgreens]. As depicted in FIG. 10, for each proposed alternative, the predictive data analysis computing entity 106, utilizing the valuation distribution data object, determined an estimated utility measure (e.g., opportunity value) based at least in part on the target event valuation (e.g., estimated cost) for the target event, the below-target event valuation, and the below-target event valuation likelihood.

Returning to FIG. 4, at step/operation 406, the predictive data analysis computing entity 106 performs a prediction-based action based at least in part on the one or more estimated utility measures.

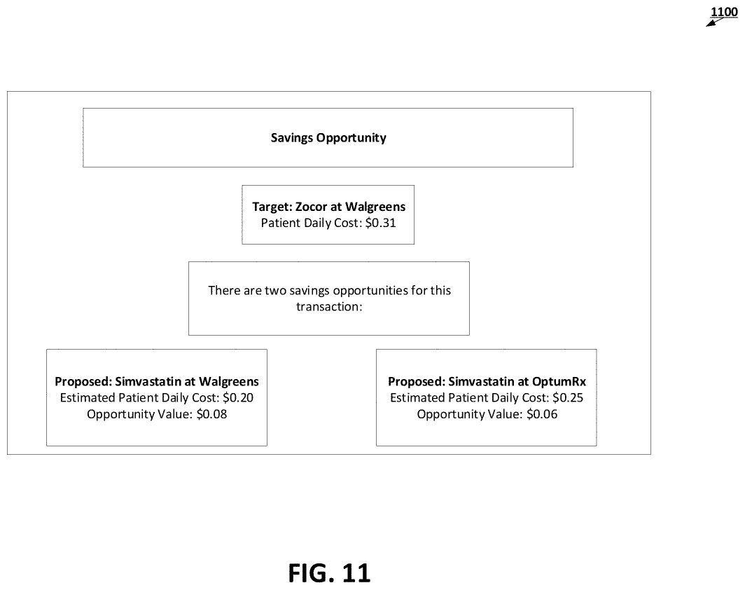

FIG. 11 provides an operation example showing a prediction output user interface 1100 that may be generated based at least in part on user interface data which are in turn generated based at least in part on the above-described predictive outputs. The external computing entity 102 may generate the user interface data and provide (e.g., transmitted, sent, and/or the like) corresponding user interface data for presentation by the prediction output user interface 1100. As depicted in FIG. 11, the user interface data may describe a savings opportunity measure corresponding to a target transaction associated with a member profile.

### VI. Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for predictive target event evaluation, the computer-implemented method comprising:
identifying, using one or more processors, a target event, wherein the target event is characterized by a plurality of target event features and a target event valuation;
determining, using the one or more processors and based at least in part on the plurality of target event features, one or more proposed event alternatives;
for each proposed event alternative:
determining, using the one or more processors, a valuation distribution entry in a valuation distribution data object for the proposed event alternative, wherein the valuation distribution entry comprises a granularity-adjusted event feature combination for the proposed event alternative and a segment valuation distribution for the granularity-adjusted event feature combination;
determining, using the one or more processors and based at least in part on the segment valuation distribution for the valuation distribution entry, a below-target event valuation and a below-target event valuation likelihood for the proposed event alternative; and
determining, using the one or more processors and based at least in part on the target event valuation, the below-target event valuation, and the below-target event valuation likelihood, an estimated utility measure for the proposed event alternative; and
performing, using the one or more processors, one or more prediction-based actions based at least in part on each estimated utility measure.

2. The computer-implemented method of claim 1, wherein generating the valuation distribution data object comprises:
identifying a plurality of highest-granularity event feature combinations;
for each highest-granularity event feature combination:
determining a plurality of related event feature combinations for the highest-granularity event feature combination, wherein the plurality of related event feature combinations comprises the highest-granularity event feature combination and one or more granularity-reduced event feature combinations for the highest-granularity event feature combination; and
determining the valuation distribution entry for the highest-granularity event feature combination to comprise the segment valuation distribution for a highest-granularity related event feature combination whose respective occurrence count satisfies an occurrence count threshold; and
generating the valuation distribution data object based at least in part on each valuation distribution entry.

3. The computer-implemented method of claim 2, wherein the plurality of highest-granularity event feature combinations comprises:
the one or more proposed event alternatives and an event feature combination corresponding to the plurality of target event features.

4. The computer-implemented method of claim 2, wherein identifying the plurality of highest-granularity event feature combinations comprises:
receiving historical event data;
generating an initial valuation distribution data object based at least in part on the historical event data; and
identifying the plurality of highest-granularity event feature combinations based at least in part on the initial valuation distribution data object.

5. The computer-implemented method of claim 1, wherein determining the one or more proposed event alternatives comprises:
retrieving, from an event alternatives database, the one or more proposed event alternatives.

6. The computer-implemented method of claim 1, wherein determining the one or more proposed event alternatives comprises:
comparing the plurality of target event features of the target event to a plurality of proposed event features of the corresponding proposed event alternative.

7. The computer-implemented method of claim 1, wherein each segment valuation distribution comprises:
one or more valuation percentiles.

8. An apparatus for predictive target event evaluation, the apparatus comprising at least one processor and at least one memory including program code, the at least one memory and the program code configured to, with the processor, cause the apparatus to at least:
identify a target event, wherein the target event is characterized by a plurality of target event features and a target event valuation;
determine, based at least in part on the plurality of target event features, one or more proposed event alternatives;
for each proposed event alternative:
determine, a valuation distribution entry in a valuation distribution data object for the proposed event alternative, wherein the valuation distribution entry comprises a granularity-adjusted event feature combination for the proposed event alternative and a segment valuation distribution for the granularity-adjusted event feature combination;
determine, based at least in part on the segment valuation distribution for the valuation distribution entry, a below-target event valuation and a below-target event valuation likelihood for the proposed event alternative; and
determine, based at least in part on the target event valuation, the below-target event valuation, and the below-target event valuation likelihood, an estimated utility measure for the proposed event alternative; and
performing one or more prediction-based actions based at least in part on each estimated utility measure.

9. The apparatus of claim 8, wherein generating the valuation distribution data object comprises:
identifying a plurality of highest-granularity event feature combinations;
for each highest-granularity event feature combination:
determining a plurality of related event feature combinations for the highest-granularity event feature combination, wherein the plurality of related event feature combinations comprises the highest-granularity event feature combination and one or more granularity-reduced event feature combinations for the highest-granularity event feature combination; and
determining the valuation distribution entry for the highest-granularity event feature combination to comprise the segment valuation distribution for a highest-granularity related event feature combination whose respective occurrence count satisfies an occurrence count threshold; and
generating the valuation distribution data object based at least in part on each valuation distribution entry.

10. The apparatus of claim 9, wherein the plurality of highest-granularity event feature combinations comprises:
the one or more proposed event alternatives and an event feature combination corresponding to the plurality of target event features.

11. The apparatus of claim 9, wherein identifying the plurality of highest-granularity event feature combinations comprises:
receiving historical event data;
generating an initial valuation distribution data object based at least in part on the historical event data; and
identifying the plurality of highest-granularity event feature combinations based at least in part on the initial valuation distribution data object.

12. The apparatus of claim 8, wherein determining the one or more proposed event alternatives comprises:
retrieving, from an event alternatives database, the one or more proposed event alternatives.

13. The apparatus of claim 8, wherein determining the one or more proposed event alternatives comprises:
comparing the plurality of target event features of the target event to a plurality of proposed event features of the corresponding proposed event alternative.

14. The apparatus of claim 8, wherein each segment valuation distribution comprises:
one or more valuation percentiles.

15. A computer program product for predictive target event evaluation, the computer program product comprising at least one non-transitory computer-readable storage medium having computer-readable program code portions stored therein, the computer-readable program code portions configured to:
identify a target event, wherein the target event is characterized by a plurality of target event features and a target event valuation;
determine, based at least in part on the plurality of target event features, one or more proposed event alternatives;
for each proposed event alternative:
determine, a valuation distribution entry in a valuation distribution data object for the proposed event alternative, wherein the valuation distribution entry comprises a granularity-adjusted event feature combination for the proposed event alternative and a segment valuation distribution for the granularity-adjusted event feature combination;
determine, based at least in part on the segment valuation distribution for the valuation distribution entry, a below-target event valuation and a below-target event valuation likelihood for the proposed event alternative; and
determine, based at least in part on the target event valuation, the below-target event valuation, and the below-target event valuation likelihood, an estimated utility measure for the proposed event alternative; and
perform one or more prediction-based actions based at least in part on each estimated utility measure.

16. The computer program product of claim 15, wherein generating the valuation distribution data object comprises:
identifying a plurality of highest-granularity event feature combinations;
for each highest-granularity event feature combination:
determining a plurality of related event feature combinations for the highest-granularity event feature combination, wherein the plurality of related event feature combinations comprises the highest-granularity event feature combination and one or more granularity-reduced event feature combinations for the highest-granularity event feature combination; and
determining the valuation distribution entry for the highest-granularity event feature combination to comprise the segment valuation distribution for a highest-granularity related event feature combination whose respective occurrence count satisfies an occurrence count threshold; and
generating the valuation distribution data object based at least in part on each valuation distribution entry.

17. The computer program product of claim 16, wherein the plurality of highest-granularity event feature combinations comprises:
the one or more proposed event alternatives and an event feature combination corresponding to the plurality of target event features.

18. The computer program product of claim 16, wherein identifying the plurality of highest-granularity event feature combinations comprises:
receiving historical event data;
generating an initial valuation distribution data object based at least in part on the historical event data; and
identifying the plurality of highest-granularity event feature combinations based at least in part on the initial valuation distribution data object.

19. The computer program product of claim 15, wherein determining the one or more proposed event alternatives comprises:
comparing the plurality of target event features of the target event to a plurality of proposed event features of the corresponding proposed event alternative.

20. The computer program product of claim 15, wherein each segment valuation distribution comprises:
one or more valuation percentiles.
